(19) United States
(12) Patent Application Publication
(10) Pub. No.: US 2009/0289993 A1
(43) Pub. Date: Nov. 26, 2009

(54) LIQUID DISCHARGING DEVICE AND METHOD OF CONTROLLING THE LIQUID DISCHARGING DEVICE

(75) Inventor: Shunji Yamaguchi, Kanagawa (JP)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignee: SONY CORPORATION, Tokyo (JP)

(21) Appl. No.: 12/469,324

(22) Filed: May 20, 2009

(30) Foreign Application Priority Data
May 26, 2008 (JP) 2008-137321

(51) Int. Cl. B41J 2/165

(52) U.S. Cl. 347/33

(57) ABSTRACT

A liquid discharging device includes a plurality of nozzles for discharging liquid, a liquid discharging head having a nozzle row in which each of the nozzles is arranged in one direction, an endless cleaning belt for cleaning a liquid discharging surface of the liquid discharging head, an installation roller on which the cleaning belt is rotatably installed, a supporting frame that supports the installation roller so that a widthwise direction of the cleaning belt is set at an angle with the arrangement direction of the nozzles, and so that the cleaning belt positioned around the installation roller is capable of contacting the liquid discharging surface, a moving unit that moves the supporting frame in the arrangement direction of the nozzles, and a rotationally driving unit that rotationally drives the installation roller.

### BACKGROUND OF THE INVENTION

1. Field of the Invention

The present invention relates to a liquid discharging device that cleans a liquid discharging surface of a liquid discharging head having a nozzle row for discharging liquid, and to a method of controlling the liquid discharging device. More specifically, the present invention relates to a technology which makes it possible to restore cleaning capability without reducing the cleaning capability during a cleaning operation and to prevent the device from becoming large even if the number of nozzle rows is increased.

2. Description of the Related Art

A liquid discharging device, such as an ink jet printer, discharges liquid from a plurality of nozzles of a liquid discharging head, and forms, for example, an image on a recording sheet. Therefore, when, for example, an image is formed while a liquid discharging surface of the liquid discharging head is stained or while the liquid, dust, etc., is adhered to the liquid discharging surface, print quality is reduced. In particular, for a full-color ink jet printer, when ink having a color differing from the color of already existing ink flows into the nozzles in a reverse direction, the color of the ink mixes with the color of the already existing ink. During printing, the ink in which the colors are mixed is discharged, thereby reducing print quality.

Therefore, in order to prevent the print quality from being reduced, various technologies for cleaning the liquid discharging surface of the liquid discharging head have hitherto been proposed. For example, a rubber blade method in which a rather hard rubber blade is pressed against and slid along the liquid discharging surface has been proposed. This method can stabilize the capability of discharging ink and restore the discharging of the ink by wiping off, for example, thickened or solidified ink, collected ink, or a stain adhered to the liquid discharging surface.

However, in the rubber blade method, a sufficient cleaning effect may not be obtained because, for example, ink adhered to the liquid discharging surface tends to remain thereon. In particular, a line ink jet printer includes a line head in which head chips for discharging ink (liquid) are arranged side by side for a printing width, and in which the ink discharging surface (liquid discharging surface) is wide. Therefore, it is difficult to uniformly press a rubber blade against the entire ink discharging surface, as a result of which a wiping operation is insufficiently performed. In addition, there are line heads having steps at their ink discharging surfaces. In such line heads, residual ink cannot be cleaned off from their steps.

FIGS. 16A and 16B are each a side sectional view showing a state in which a line head 120 is cleaned by a related rubber blade method.

As shown in FIG. 16A, in the rubber blade method, a rubber blade 141 is brought into contact with an ink discharging surface 121 of the line head 120, and the rubber blade 141 is moved in a nozzle arrangement direction along the ink discharging surface 121 as indicated by an arrow, to wipe off, for example, collected ink adhered to the ink discharging surface 121. Therefore, the rubber blade 141 is required to uniformly contact the ink discharging surface 121 without any gap therebetween.

However, as shown in FIG. 16B, when the ink discharging surface 121 has a step, the rubber blade 141 does not contact a corner of the step. That is, a gap is formed between the corner of the step and the rubber blade 141 that is bent by being press-contacted against the ink discharging surface 121. This does not allow, for example, residual ink adhered to the gap, or, for example, dust or foreign matter driven to the corner of the step by the movement of the rubber blade 141 to be wiped off.

A related wipe roller method is available. In this method, instead of the rubber blade 141, a cleaning roller (not shown), formed of foam material having excellent water-absorbing property, is slid or rotationally moved along the ink discharging surface 121, to wipe off, for example, residual ink at the corner of the step of the ink discharging surface 121. If this method is used, a gap is not formed at the corner of the step because the porous foam material of the cleaning roller is pressed in correspondence with the step. In addition, since capillarity occurs in pores (cells) in the interior of the porous foam material, it is possible to make use of the capillarity to clean off, for example, collected ink adhered to the ink discharging surface 121 while absorbing the collected ink. (Refer to, for example, Japanese Patent No. 2738855 (Patent Document 1).)

A related cleaning cloth method that uses an annular cleaning cloth (not shown) instead of the cleaning roller is also available. In this method, using a feed roller, an operating surface of the cleaning cloth including a guide is two-dimensionally pressed against and moved along the ink discharging surface 121. The cleaning cloth is folded and accommodated in an accommodation chamber, and can be repeatedly used by successively supplying it from an exit. (Refer to, for example, Japanese Unexamined Patent Application Publication No. 11-207977 (Patent Document 2).)

Further, a related technology using a cleaning belt (not shown) is available. In the cleaning belt method, at a position situated outwardly of an area where printing is performed by an ink jet printer, resilient rollers are rotatably disposed around an axial line parallel to a nozzle arrangement direction so as to oppose nozzles. The cleaning belt is provided around outer peripheries of the rollers. In the cleaning belt method, the cleaning belt for cleaning the nozzles is press-contacted against the ink discharging surface 121 by resilient actions of the rollers. Therefore, if the cleaning belt positioned so as to oppose the nozzles is rotated, for example, a stain on the ink discharging surface 121 can be rubbed off. (Refer to, for example, Japanese Unexamined Patent Application Publication No. 5-92575 (Patent Document 3).)

### SUMMARY OF THE INVENTION

However, in the wiper roller method discussed in Patent Document 1, since ink absorbed by the soft porous foam material of the cleaning roller once and confined in the interior of the foam material is not easily evaporated, it takes time for the moisture of the ink to dry up. Therefore, the moisture of the ink is collected each time a cleaning operation is performed, and the foam material is eventually saturated with the moisture, thereby reducing absorbing power of the porous foam material. Moreover, when the foam material is saturated with the moisture, the ink collected in the cleaning roller flows in a reverse direction to the ink discharging surface 121. Therefore, this may stain and damage the ink discharging surface 121 even more.

In particular, for the line ink jet printer including the line head 120, the ink discharging surface 121 is much larger than that used in a serial method that performs printing by moving a head. Therefore, a cleaning range is wide, and the amount of ink absorbed by the porous foam material of the cleaning roller is large. Consequently, the problem in which the ink flows in the reverse direction towards the ink discharging surface 121 becomes noticeable. That is, even if, for example, collected ink at the ink discharging surface 121 is properly absorbed at a cleaning start position, the cleaning performance is reduced as a cleaning end position is approached. As a result, the ink discharging surface 121 is typically stained towards a side where the latter half of the cleaning is performed (right side in FIG. 16). Therefore, the probability that locations where ink discharge failures occur are concentrated towards the side where the latter half of the cleaning is performed is increased. To overcome this problem, it is necessary to, for example, considerably increase the outside diameter of the porous foam material, or set the cleaning roller as a component that is periodically replaced.

In the cleaning cloth method discussed in Patent Document 2, since the cleaning cloth is folded and accommodated in the accommodation chamber, the allowable absorption amount of, for example, ink is increased. Therefore, the problem in which the ink flows in the reverse direction towards the ink discharging surface 121 from the cleaning cloth does not occur. Consequently, unlike the wiper roller method, the cleaning cloth method can be applied even if the line head 120 is to be cleaned.

However, since the cleaning cloth cleans the flat operating surface by being pressed against the ink discharging surface 121, the cleaning cloth method has the same problem as the rubber blade method. That is, at the corner of the step of the ink discharging surface 121, the cleaning cloth no longer contacts the ink discharging surface 121, thereby forming a gap. Therefore, for example, residual ink adhered to the gap cannot be wiped off. Consequently, a sufficient cleaning effect of the ink discharging surface 121 cannot be obtained.

Regarding this point, as with the wiper roller method discussed in Patent Document 1, the cleaning belt method discussed in Patent Document 3 makes it possible for the cleaning belt to follow the step of the ink discharging surface 121 by the resilient rollers. In addition, similarly to the cleaning cloth method discussed in Patent Document 2, an allowable absorption amount of, for example, ink is increased by the endless cleaning belt provided around a pair of rollers.

However, since, in the technology discussed in Patent Document 3, the rollers are disposed so as to be rotatable around the axial line parallel to the nozzle arrangement direction, in particular, problems are produced for the line ink jet printer including the line head 120. That is, in the line head 120, a large number of nozzles for increasing printing speed are disposed, thereby increasing the size of the ink discharging surface 121. This causes the width of the cleaning belt to increase (that is, the cleaning belt to become longer in the nozzle arrangement direction) in accordance with the number of rows of nozzles. Therefore, the size of the ink jet printer is inevitably increased.

Therefore, it is desirable to make it possible to restore cleaning capability without reducing the cleaning capability during a cleaning operation, and obtain a sufficient cleaning effect and prevent the size of a liquid discharging device from being increased even if a line ink jet printer is used.

The present invention makes it possible to overcome the aforementioned problems as follows.

According to an embodiment of the present invention, there is provided a liquid discharging device including a plurality of nozzles for discharging liquid, a liquid discharging head having a nozzle row in which each of the nozzles is arranged in one direction, an endless cleaning belt for cleaning a liquid discharging surface of the liquid discharging head, an installation roller on which the cleaning belt is rotatably installed, a supporting frame that supports the installation roller so that a widthwise direction of the cleaning belt is set at an angle with the arrangement direction of the nozzles, and so that the cleaning belt positioned around the installation roller is capable of contacting the liquid discharging surface, moving means for moving the supporting frame in the arrangement direction of the nozzles, and rotationally driving means for rotationally driving the installation roller.

According to another embodiment of the present invention, there is provided a method of controlling the liquid discharging device according to the embodiment. In this method, the moving means moves the supporting frame when the liquid discharging surface and the cleaning belt are in contact with each other, and the rotationally driving means rotationally drives the installation roller when the liquid discharging surface and the cleaning belt are not in contact with each other.

In the liquid discharging device and the method of controlling the liquid discharging device according to the embodiments of the present invention, an endless cleaning belt for cleaning the liquid discharging surface of the liquid discharging head is provided, and is rotatably installed around the installation roller. In addition, the installation roller is supported by the supporting frame so that the cleaning belt positioned around the installation roller can contact the liquid discharging surface, and the supporting frame is moved by the moving means. Therefore, the liquid discharging surface is cleaned by moving a contact portion of the cleaning belt positioned around the installation roller. The contact portion of the cleaning belt can be changed by rotationally driving the installation roller by the rotationally driving means.

Further, the installation roller is supported by the supporting frame so that the widthwise direction of the cleaning belt is set at an angle (of, for example, 90 degrees) with the nozzle arrangement direction. The supporting frame moves in the nozzle arrangement direction. Therefore, the width of the cleaning belt is not made wide (that is, the cleaning belt is not made long in the nozzle arrangement direction) in accordance with the number of rows of nozzles.

According to the embodiments of the present invention, since the cleaning belt positioned around the installation roller contacts the liquid discharging surface, even if the liquid discharging surface has a step, the cleaning belt is pressed against the liquid discharging surface by the installation roller. Therefore, a sufficient cleaning effect is obtained so that, for example, ink does not remain in a corner of the step. Changing the contact portion of the cleaning belt makes it possible to restore cleaning capability without reducing the cleaning capability during a cleaning operation. Further, since the width of the cleaning belt is not made wide (that is, since the cleaning belt is not made long in the nozzle arrangement direction) in accordance with the number of rows of nozzles, it is possible to prevent the liquid discharging device from becoming large.

### BRIEF DESCRIPTION OF THE DRAWINGS

FIG. 1 is a schematic view of the entire structure of an ink jet printer according to an embodiment;

FIG. 2 is a plan view of a line head of the ink jet printer shown in FIG. 1 as seen from an ink-discharging-surface side;

FIG. 3 is an exploded perspective view of a head module of the line head shown in FIG. 2;

FIGS. 4A and 4B are a perspective view of the head module shown in FIG. 3 as seen from the ink-discharging-surface side, and a sectional view of the vicinity of a head chip;

FIG. 5 is a side view of a cleaning device of the ink jet printer according to the embodiment;

FIGS. 6A and 6B are each an enlarged side view of the vicinity of a cleaning belt of the cleaning device shown in FIG. 5;

FIG. 7 is a flowchart of a method of controlling the ink jet printer shown in FIG. 5;

FIGS. 8A and 8B are schematic views of intermediate steps of cleaning the ink discharging surface by controlling the ink jet printer shown in FIG. 5, and correspond to Steps S1 and S2 shown in FIG. 7;

FIGS. 9A and 9B are schematic views of intermediate steps of cleaning the ink discharging surface by controlling the ink jet printer shown in FIG. 5, and correspond to Steps S3 to S6 shown in FIG. 7;

FIGS. 10A and 10B are schematic views of an intermediate step of cleaning the ink discharging surface by controlling the ink jet printer shown in FIG. 5, and correspond to Step S4 shown in FIG. 7;

FIGS. 11A and 11B are schematic views of intermediate steps of cleaning the ink discharging surface by controlling the ink jet printer shown in FIG. 5, and correspond to Steps S7 and S8 shown in FIG. 7;

FIGS. 12A and 12B are schematic views of intermediate steps of cleaning the ink discharging surface by controlling the ink jet printer shown in FIG. 5, and correspond to Steps S9 to S12 shown in FIG. 7;

FIGS. 13A and 13B are schematic views of intermediate steps of cleaning the ink discharging surface by controlling the ink jet printer shown in FIG. 5, and correspond to Steps S13 and S14 shown in FIG. 7;

FIGS. 14A and 14B are schematic views of intermediate steps of cleaning the ink discharging surface by controlling the ink jet printer shown in FIG. 5, and correspond to Steps S15 to S18 shown in FIG. 7;

FIGS. 15A and 15B are schematic views of intermediate steps of cleaning the ink discharging surface by controlling the ink jet printer shown in FIG. 5, and correspond to Steps S19 to S21 shown in FIG. 7; and

FIGS. 16A and 16B are each a side sectional view showing a state in which a line head is cleaned by a related rubber blade method.

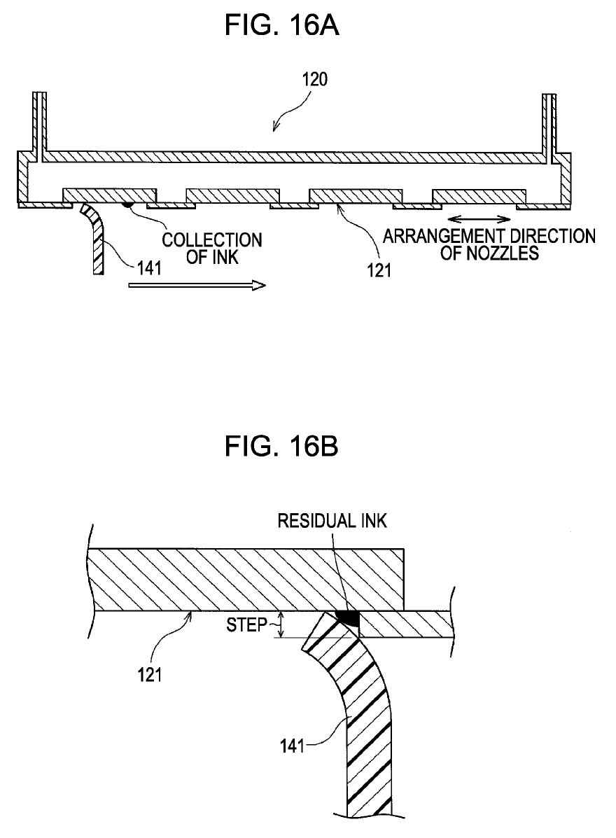

### DESCRIPTION OF THE PREFERRED EMBODIMENTS

An embodiment of the present invention will hereunder be described with reference to the drawings.

In the embodiment below, an ink jet printer 10 in which liquid that is discharged is ink is used as an exemplary liquid discharging device according to the embodiment of the present invention. The ink jet printer 10 is a line ink jet printer including a line head 20 (corresponding to a liquid discharging head in the present invention) provided in correspondence with a printing width (such as an A4 size), and is a full-color ink jet printer.

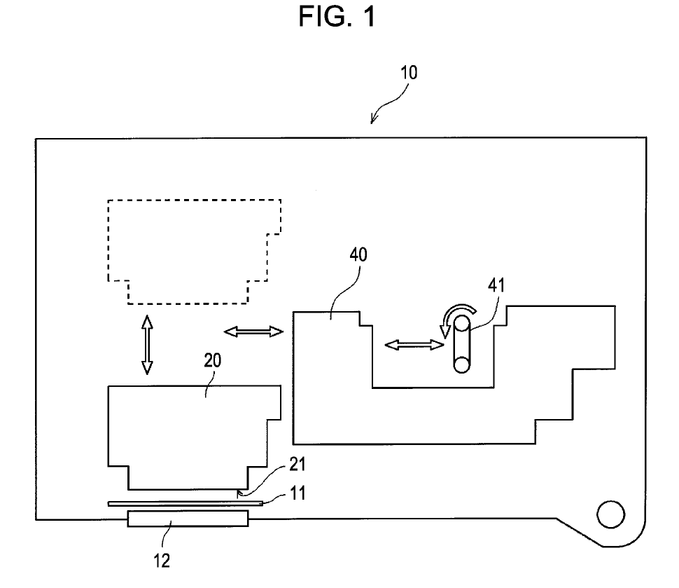

FIG. 1 is a schematic view of the entire structure of the ink jet printer 10 according to the embodiment.

As shown in FIG. 1, the ink jet printer 10 includes a print table 11, the line head 20, a head cap 12, and a cleaning device 40. The print table 11 supports substantially horizontally a recording sheet fed from a sheet-feed section (not shown). The line head 20 discharges ink from an ink discharging surface 21 (corresponding to a liquid discharging surface in the present invention) to form an image. The head cap 12 is provided for protecting the ink discharging surface 21 of the line head 20. The cleaning device 40 is provided with a cleaning belt 41 for cleaning the ink discharging surface 21 of the line head 20.

The ink jet printer 10 also includes a raising-lowering unit that raises and lowers the line head 20 as indicated by a vertical double-headed arrow shown in FIG. 1. The raising-lowering unit may include, for example, a drivingly rotating gear, belt, cam, or piston, or a combination thereof. The raising-lowering unit raises and lowers the line head 20 between a position (indicated by a solid line shown in FIG. 1) where an image is formed on a recording sheet when the ink discharging surface 21 is lowered to a location just above the print table 11, a position where the ink discharging surface 21 is covered by the head cap 12 when the ink discharging surface 21 is further lowered, and a position (indicated by dotted lines shown in FIG. 1) where the ink discharging surface 21 can be cleaned when the ink discharging surface 21 is considerably raised. The recording sheet is fed onto the print table 11 by a sheet-feed roller (not shown), and the recording sheet that is printed by the line head 20 is sent out as it is by a sheet-discharge roller (not shown) and is discharged onto a paper tray (not shown).

The ink jet printer 10 further includes a moving unit that moves the cleaning device 40 as indicated by a horizontal double-headed arrow shown in FIG. 1. The moving unit may include, for example, a drivingly rotating gear, belt, cam, or piston, or a combination thereof. When the line head 20 is situated at the position where it is raised (indicated by the dotted lines shown in FIG. 1), the cleaning device 40 can be moved so as to be positioned directly below the ink discharging surface 21.

The cleaning device 40 is also provided with a moving unit that moves the cleaning belt 41 as indicated by a horizontal double-headed arrow shown in FIG. 1, and a rotationally driving unit that rotationally drives the cleaning belt 41 as indicated by a counterclockwise arrow shown in FIG. 1. Therefore, after positioning the cleaning device 40 directly below the ink discharging surface 21 and bringing the cleaning belt 41 into contact with the ink discharging surface 21, if the cleaning belt 41 is moved by the moving unit, for example, foreign matter, dust, or a stain of ink adhered to the ink discharging surface 21 can be wiped off. If the cleaning belt 41 is rotated by the rotationally driving unit, a contact portion (wipe portion) of the cleaning belt 41 with respect to the ink discharging surface 21 can be changed.

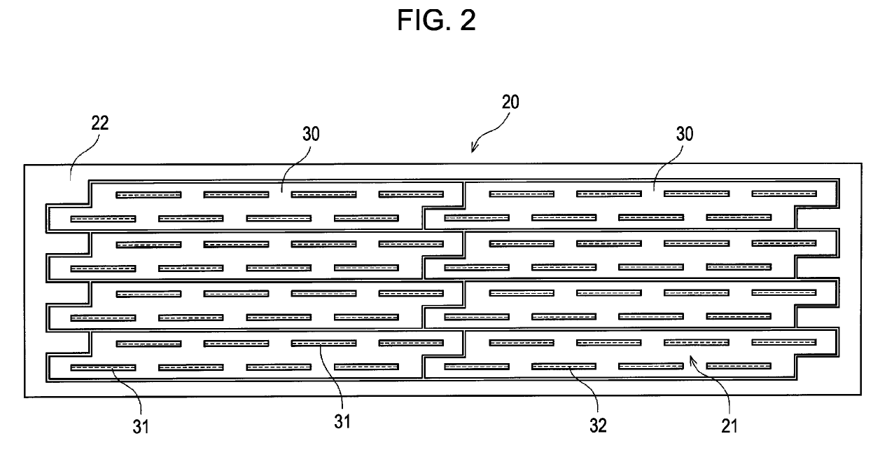

FIG. 2 is a plan view of the line head 20 of the ink jet printer 10 shown in FIG. 1 as seen from an ink-discharging-surface-21 side.

As shown in FIG. 2, the line head 20 includes a head frame 22 and a plurality of head modules 30 held by the head frame 22. That is, each head module 30 is inserted into the head frame 22 by connecting two head modules in series to each other in the longitudinal direction of the head frame 22. Such two head modules 30 cover a length equivalent to a width of a recording sheet having a maximum size allowing printing (such as a horizontal width of an A4 size sheet), in order to perform printing using one color. Four layers of such two head modules 30 connected in series (a total of eight head modules 30) are provided. By discharging ink of four colors, yellow (Y) ink, magenta (M) ink, cyan (C) ink, and black (K) ink, from the respective layers, a full-color image is formed.

Each head module 30 is provided with a plurality of head chips 31. That is, in each head module 30, two rows of four head chips 31 (a total of eight head chips 31) are disposed in a staggered arrangement. In each head chip 31, a plurality of nozzles 32 for discharging ink are disposed in one direction in nozzle rows. Therefore, the nozzles 32 are not only disposed in two rows in parallel with each other for each head module 30, but also are disposed in eight rows in parallel with each other in the entire line head 20. The intervals between the nozzles 32 are all equal to each other including the nozzles 32 adjacent to each other in the staggered arrangement.

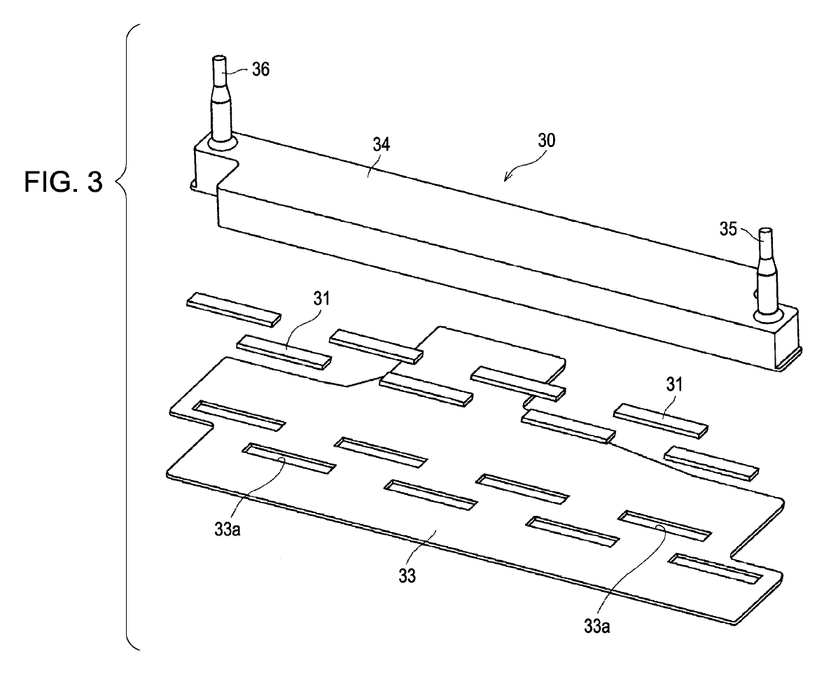

FIG. 3 is an exploded perspective view of the head module 30 of the line head shown in FIG. 2.

As shown in FIG. 3, the head module 30 includes eight head chips 31, a flexible sheet 33 where each head chip 31 is disposed, and an ink tank 34. The ink discharging surface 21 shown in FIG. 2 is a lower surface of the flexible sheet 33 shown in FIG. 3.

Here, the flexible sheet 33 is a flexible wiring board for electrically connecting the head chips 31 and a control base (not shown) to each other. The flexible sheet 33 is formed of polyimide and has a thickness of approximately 50 μm. Openings 33a are formed in a staggered arrangement in the flexible sheet 33. In each head chip 31, all nozzles 32 (see FIG. 2) are positioned in the openings 33a. The head chips 31 are joined to the flexible sheet 33 so that the head chips 31 close the respective openings 33a.

The ink tank 34 is joined to the flexible sheet 33 so as to cover each head chip 31. The ink tank 34 constitutes a common flow path for supplying ink to each head chip 31. The ink tank 34 has an ink supplying port 35 and an ink discharging port 36. The ink supplying port 35 is connected to an ink cartridge (not shown) and is provided for supplying ink into the common path. The ink discharging port 36 is provided for discharging the ink in the common flow path. Therefore, the ink in the ink cartridge flows into the common flow path in the ink tank 34 through the ink supplying port 35, and is supplied to each head chip 31. When the head module 30 is inserted into the head frame 22 (see FIG. 2), a portion of the flexible sheet 33 projecting from the head module 30 is bent along a side surface of the ink tank 34.

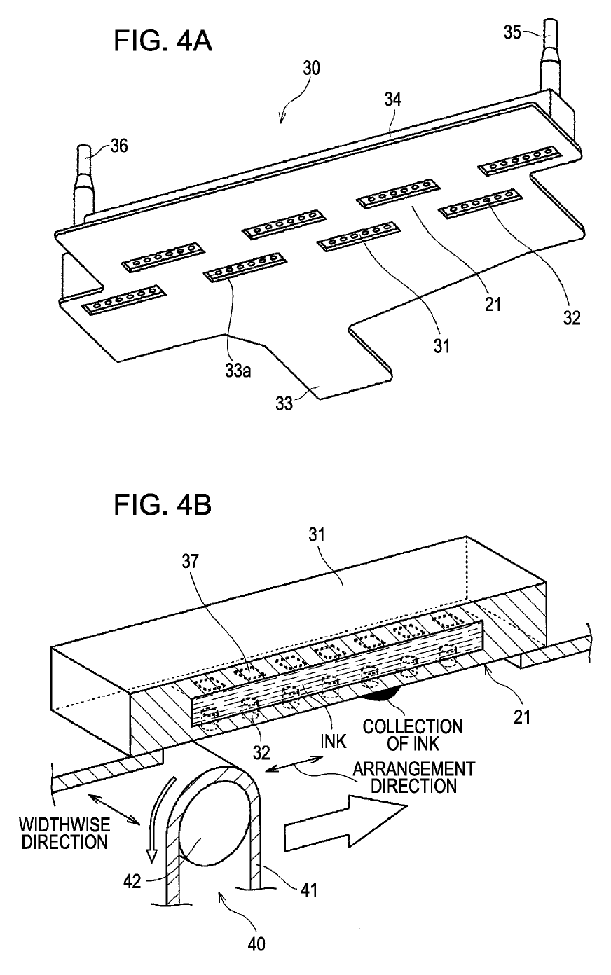

FIGS. 4A and 4B are a perspective view of the head module 30 shown in FIG. 3 as seen from the ink-discharging-surface side, and a sectional view of the vicinity of the head chip 31.

As shown in FIG. 4A, in the head module 30, eight head chips 31 are disposed in a staggered arrangement in an internal space between the flexible sheet 33 and the ink tank 34. All of the nozzles 32 of each head chip 31 are positioned in the corresponding one of the openings 33a of the flexible sheet 33. Therefore, the ink discharging surface 21 is formed by the surface of the flexible sheet 33 excluding the openings 33a and the surface of each head chip 31 in the corresponding one of the openings 33a.

As shown in FIG. 4B, in the head chip 31, a plurality of heating resistors 37 are arranged at positions opposing the corresponding nozzles 32. An ink liquid chamber is provided between the nozzles 32 and the corresponding heating resistors 37. When ink is supplied from the ink supplying port 35 (see FIG. 4A), not only is the vicinity of the head chip 31 filled with the ink, but also the interior of the liquid chamber of the head chip 31 is filled with the ink.

When a pulse current of a short time (such as 1 to 3 μsec) is made to flow to the heating resistors 37 through the flexible sheet 33 (see FIG. 4A) on the basis of a command from a control base (not shown), the heating resistors 37 are heated rapidly. Therefore, ink bubbles are formed (the ink boils) where the ink contacts the heating resistors 37, as a result of which a predetermined volume of ink is pushed aside by the expansion of the bubbles. This generates a discharge pressure, thereby causing ink having a volume that is equivalent to the volume of the ink that is pushed aside to be discharged from the nozzles 32.

In this way, in the head chip 31, the heating resistors 37 are heated to discharge ink from the nozzles 32, so that an image is formed on a recording sheet that is fed to a location directly below the nozzles 32. Therefore, as ink is repeatedly discharged, ink may collect at the ink discharging surface 21, or dust or foreign matter may adhere to the ink discharging surface 21. If such a state is ignored, the discharge of ink from the nozzles 32 is obstructed, as a result of which discharge failure, such as ink not being discharged or not being completely discharged, may occur.

In the full-color line head 20 (see FIG. 2), collected ink having different colors also adhere to the ink discharging surface 21. Therefore, the collected ink having a color differing from that of already existing ink in the head module 30 may flow in a reverse direction from the nozzles 32 and flow into the head module 30. This causes the different color of the collected ink to mix with the color of the already existing ink, as a result of which ink having a mixed color is discharged. This reduces image quality, such as causing a change in density, a difference in hue, or unevenness caused by streaks.

Accordingly, for wiping off, for example, the collected ink at the ink discharging surface 21, the cleaning device 40 is provided. The cleaning device 40 includes the endless cleaning belt 41 and installation rollers 42 around which the cleaning belt 41 is rotatably installed. The cleaning belt 41 is disposed so that its widthwise direction is separated by an angle (of 90 degrees in the embodiment) with a nozzle-32 arrangement direction. The cleaning belt 41 positioned around the installation rollers 42 can contact the ink discharging surface 21. In addition, the width of the cleaning belt 41 is formed so as to be slightly larger than an interval between the rows of nozzles 32 at both ends of an arrangement in which the nozzles 32 are disposed in eight rows in a short-side direction of the line head 20 (see FIG. 2). That is, the cleaning belt 41 has a width that allows it to cover the entire width of the ink discharging surface 21 shown in FIG. 2.

In the cleaning device 40, the cleaning belt 41 is moved in the nozzle-32 arrangement direction by a moving unit that moves the cleaning belt 41 as indicated by an arrow shown in FIG. 4B extending obliquely upwards towards the left. Therefore, for example, foreign matter, dust, or collected ink adhered to the ink discharging surface 21 is successively wiped off by the movement of the cleaning belt 41.

Even if the number of head modules 30 that are connected in series is increased for increasing a width of a printable recording sheet (for example, from a horizontal width of an A4 size to a horizontal width of an A3 size sheet), the width of the cleaning belt 41 of the cleaning device 40 according to the embodiment is not changed. That is, even if the width of the recording sheet is increased, it is possible to use it by only increasing the distance of movement of the cleaning belt 41 without changing the width of the cleaning belt 41. Therefore, it is possible to prevent the size of the cleaning device 40 from increasing.

Further, the cleaning belt 41 is rotated around the installation rollers 42 as indicated by a counterclockwise arrow shown in FIG. 4B by a rotationally driving unit that rotationally drives the installation roller 42. Therefore, a portion of the cleaning belt contacting the ink discharging surface 21 and stained by a wiping operation can be changed by rotationally driving the installation roller 42. Consequently, it is possible to easily restore cleaning capability of the cleaning belt 41. The direction in which the cleaning belt 41 rotates around the installation rollers 41 may be a clockwise direction.

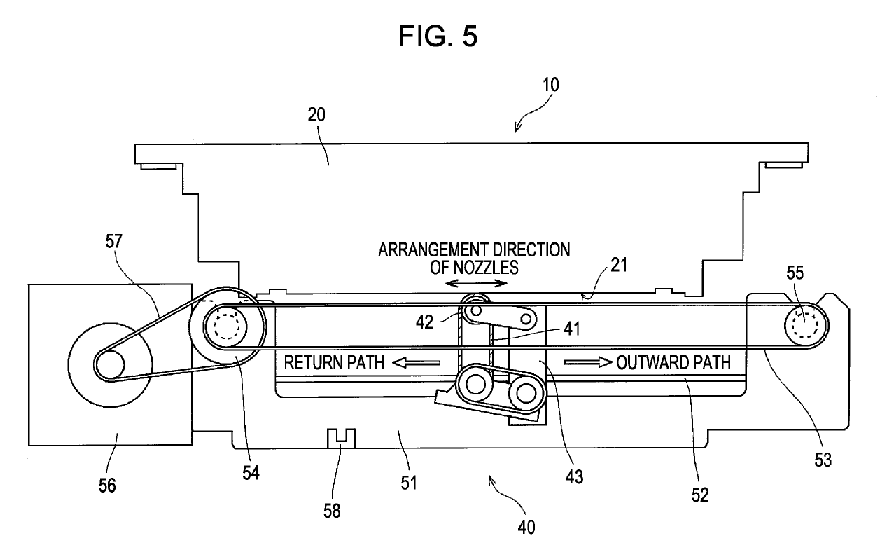

FIG. 5 is a side view of the cleaning device 40 of the ink jet printer 10 according to the embodiment.

As shown in FIG. 5, the endless cleaning belt 41 for cleaning the ink discharging surface 21 of the line head 20 is installed so as to be rotatable around the installation rollers 42. The installation rollers 42 are supported by a belt frame 43 (corresponding to a supporting frame in the present invention). The belt frame 43 reciprocates in the nozzle-arrangement direction by a moving unit that moves the belt frame 43 as indicated by horizontal arrows shown in FIG. 5. Although, in FIG. 5, the rightward direction corresponds to an outward path and the leftward direction corresponds to a return path, the rightward direction may correspond to the return path and the leftward direction may correspond to the outward path.

The moving unit of the belt frame 43 may include, for example, a drivingly rotating gear, belt, cam, or piston, or a combination thereof. In addition, in the embodiment, a guide shaft 52, a moving driving belt 53, a moving driving pulley 54, a tension pulley 55, a belt moving motor 56, and a movement transmitting belt 57 constitute the moving unit of the belt frame 43.

Here, the belt frame 43 is movably inserted into the guide shaft 52 provided in a longitudinal direction of the base frame 51. The moving driving belt 53 is engaged with and joined to a portion of the belt frame 43. The moving driving belt 53 is installed between the moving driving pulley 54 and the tension pulley 55 so as to be parallel to the guide shaft 52. The moving driving pulley 54 is provided at one end of the base frame 51, and the tension pulley 55 is provided at the other end of the base frame 51.

The moving driving pulley 54 is rotationally driven by the belt moving motor 56 through the movement transmitting belt 57. Therefore, if the belt driving motor 56 is rotated in a forward direction or a reverse direction, it is possible to rotate the moving driving pulley 54 in the forward direction or the reverse direction, to rotate the moving driving belt 53 around the moving driving pulley 54. Consequently, the forward or reverse rotation of the belt driving motor 56 causes the belt frame 43 to reciprocate along the guide shaft 52 at a speed that is the same as a rotating speed of the moving driving belt 53. A cleaning operation ends with one reciprocating movement, and a home position (reference position) of the belt frame 43 is detected by a position sensor 58 provided at the base frame 51.

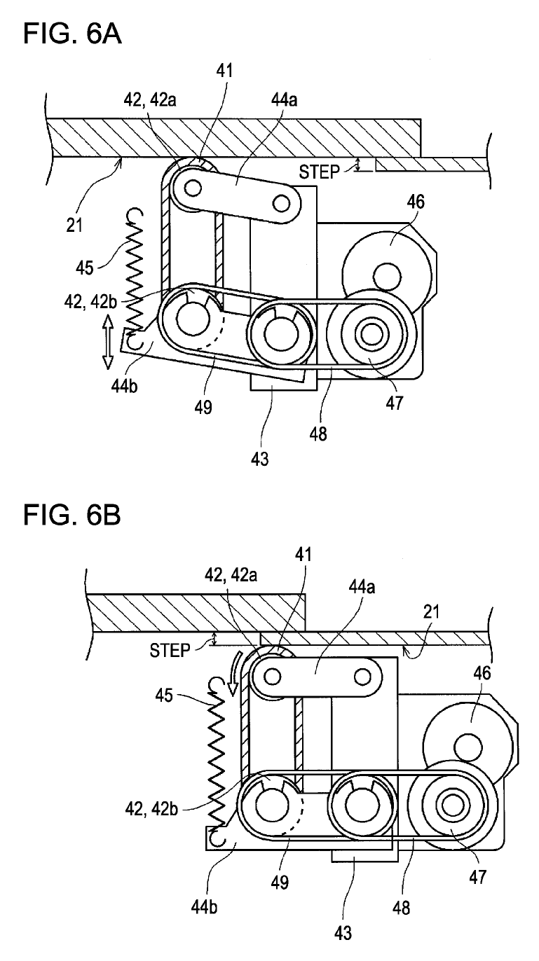

FIGS. 6A and 6B are each an enlarged side view of the vicinity of the cleaning belt 41 of the cleaning device 40 shown in FIG. 5.

As shown in FIGS. 6A and 6B, the cleaning belt 41 is an endless belt, in which, by the pair of upper and lower installation rollers 42 (that is, an installation roller 42a and an installation roller 42b), the cleaning belt 41 is installed while a proper tension is applied thereto. The cleaning belt 41 is formed of a porous foam material of an open-cell type having flexibility, water-absorbing property, and air permeability. Therefore, the cleaning belt 41 can, for example, absorb, for example, collected ink adhered to the ink discharging surface 21. In addition to the porous foam material, for example, unwoven cloth or condensed optical fiber may be used for the cleaning belt 41.

The installation rollers 42 are supported by the belt frame 43 through an upper link 44a and a lower link 44b, so that a four link mechanism is provided. Therefore, the cleaning belt 41 installed around the installation rollers 42 is movable upward and downward parallel to the belt frame 43. The lower link 44b is biased upward by a raising spring 45 so that the cleaning belt 41 positioned around the upper installation roller 42a contacts the ink liquid discharging surface 21 under a predetermined pressure. Therefore, even if there is a step at the ink liquid discharging surface 21, the lower link 44b moves upward and downward as indicated by a vertical double-headed arrow shown in FIG. 6A. As a result, since the installation roller 42 also moves upward and downward, the cleaning belt 41 follows the step formed at the ink liquid discharging surface 21.

Further, the cleaning belt 41 can rotate as indicated by a counterclockwise arrow shown in FIG. 6B by a rotationally driving unit that rotationally drives the lower installation roller 42b. The rotationally driving unit may include, for example, a drivingly rotating gear, belt, cam, or piston, or a combination thereof. In addition, in the embodiment, for example, a belt rotating motor 46, a rotationally driving pulley 47, a rotation transmitting belt 48, and a rotationally driving belt 49 constitute the rotationally driving unit of the installation roller 42b.

Here, the installation roller 42b is rotationally driven by the belt rotating motor 46. That is, if the belt rotating motor 46 is rotationally driven, the rotationally driving pulley 47 is rotated in accordance with the rotational driving of the belt rotating motor 46. Rotating force thereof is transmitted to the installation roller 42b through the rotation transmitting belt 48 and the rotationally driving belt 49. Therefore, since the cleaning belt 41 rotates due to the rotation of the belt rotating motor 46, if the belt rotating motor 46 is controlled, the cleaning belt 41 can be rotated at a predetermined timing and by a predetermined movement amount.

Accordingly, in the ink jet printer 10 according to the embodiment, the cleaning belt 41 contacts the ink liquid discharging surface 21 under a predetermined pressure, and moves in the direction of arrangement of the nozzles 32 (see FIG. 4). Therefore, for example, collected ink on the ink liquid discharging surface 21 can be wiped off and cleaned off. Since a portion of the cleaning belt 41 contacting the ink discharging surface 21 and stained by a wiping operation can be changed if the cleaning belt 41 is rotated, cleaning capability is restored by rotating the cleaning belt 41 at a proper timing.

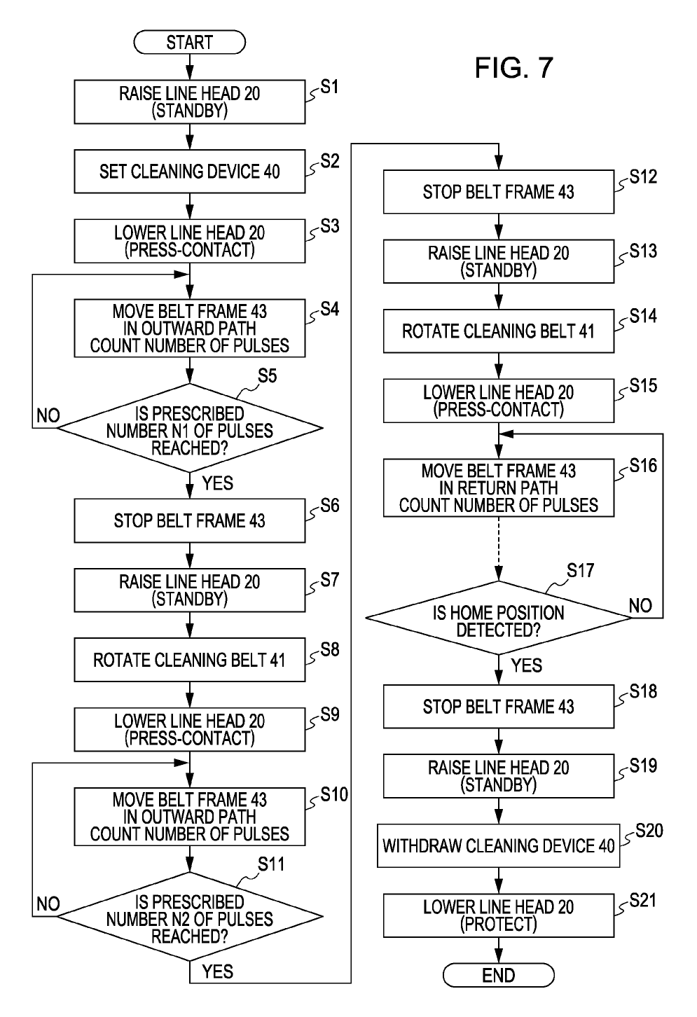

FIG. 7 is a flowchart of a method of controlling the ink jet printer 10 shown in FIG. 5.

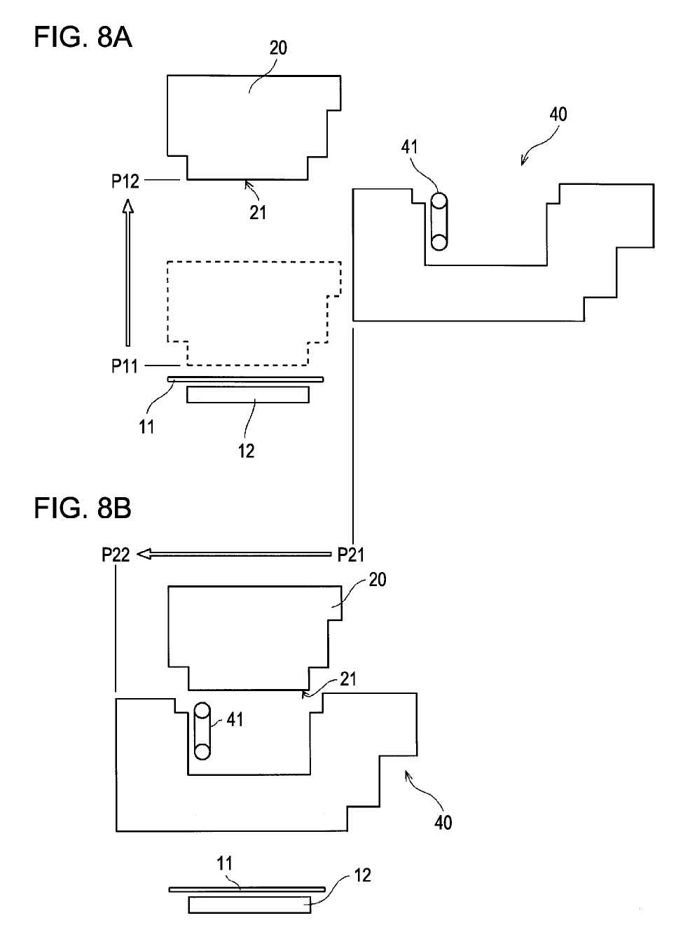

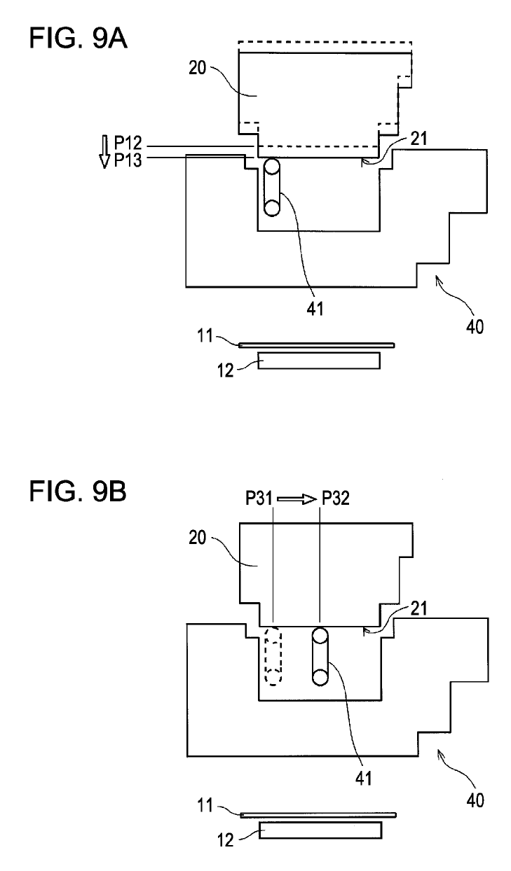

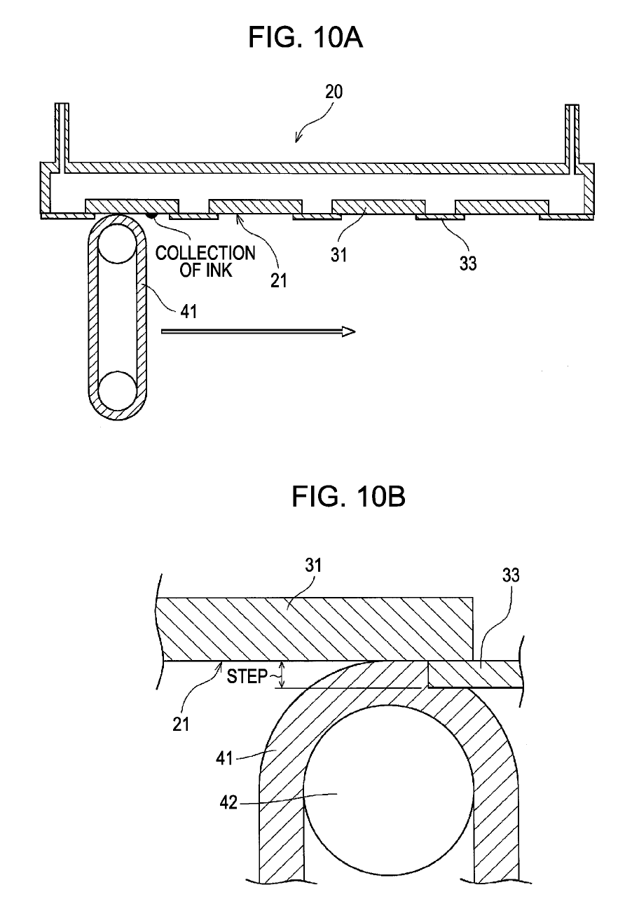

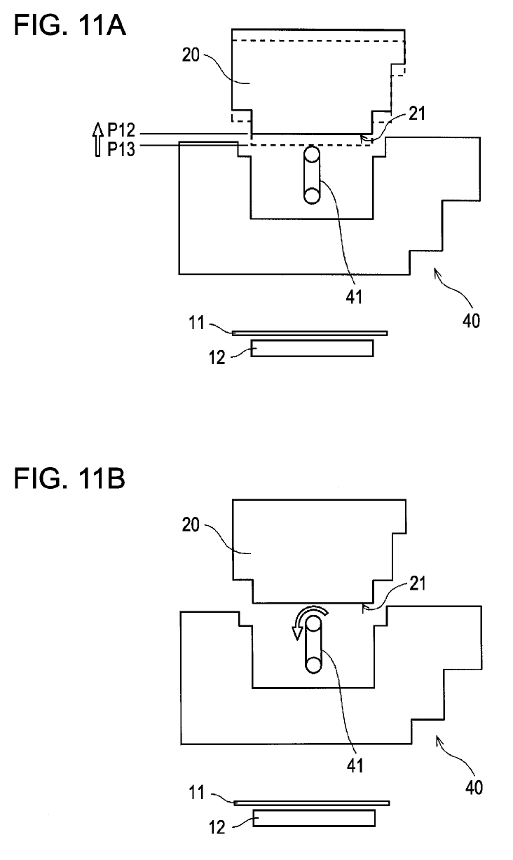

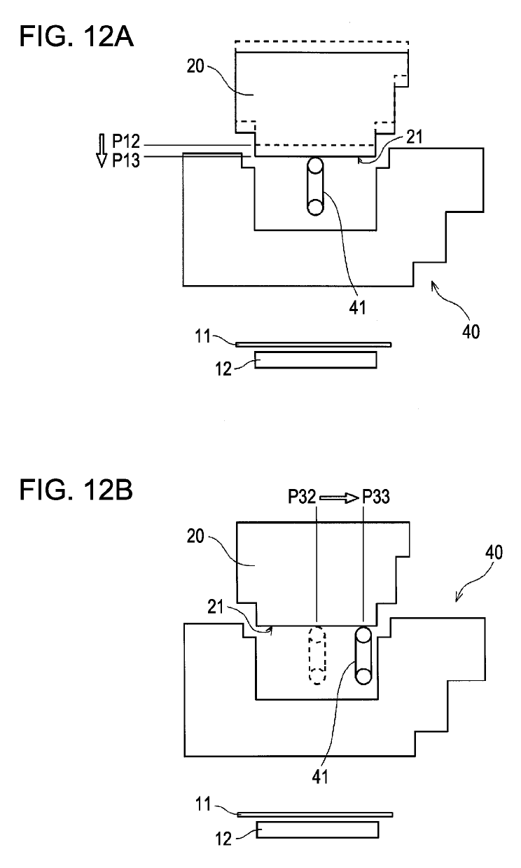

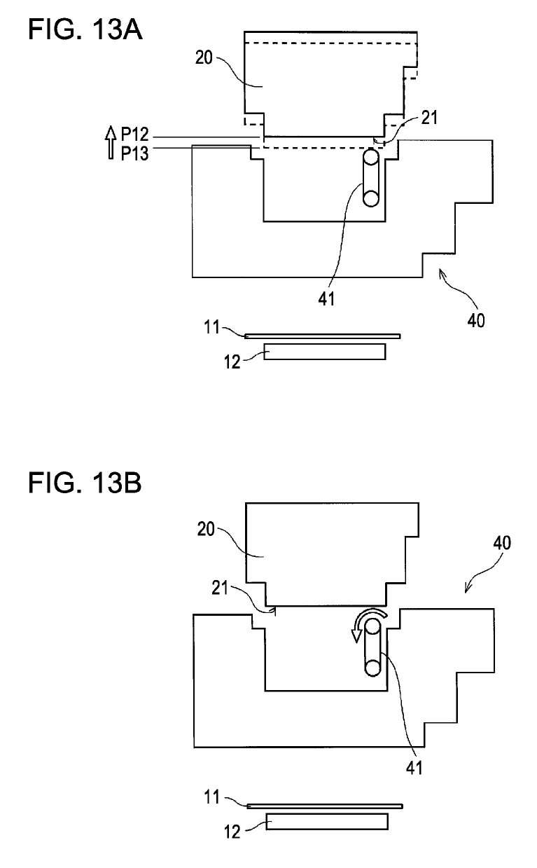

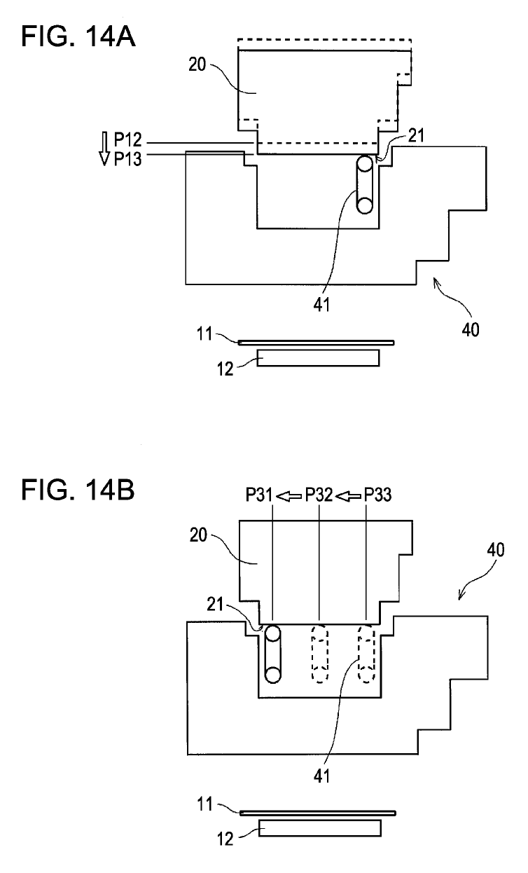

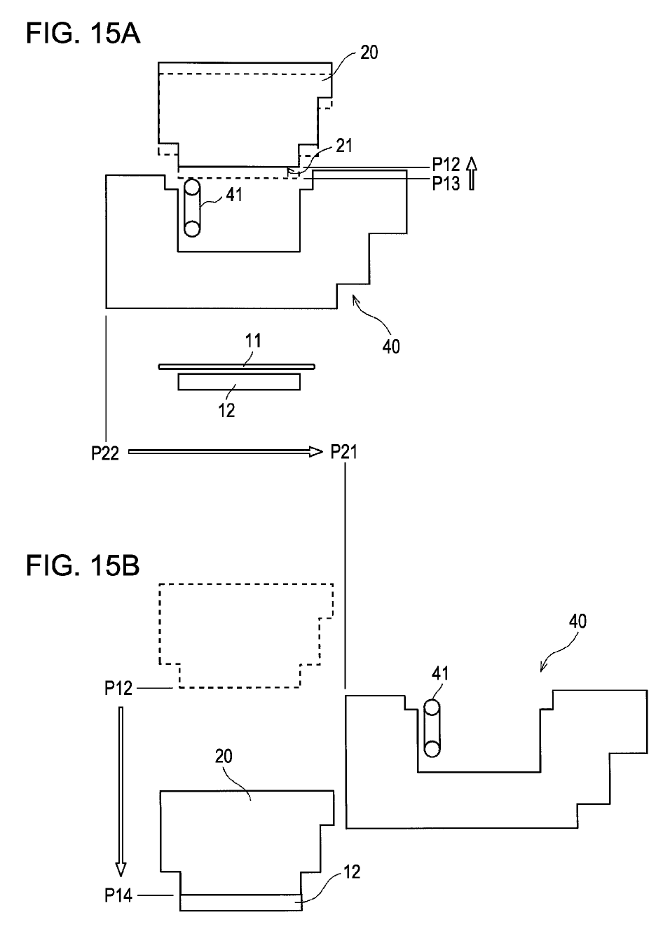

FIGS. 8 to 15 are schematic views of respective intermediate steps of cleaning the ink discharging surface 21 by controlling the ink jet printer 10 shown in FIG. 5. FIGS. 8A and 8B correspond to Steps S1 and S2 shown in FIG. 7. FIGS. 9A and 9B correspond to Steps S3 to S6 shown in FIG. 7. FIGS. 10A and 10B correspond to Step S4 shown in FIG. 7. FIGS. 11A and 11B correspond to Steps S7 and S8 shown in FIG. 7. FIGS. 12A and 12B correspond to Steps S9 to S12 shown in FIG. 7. FIGS. 13A and 13B correspond to Steps S13 and S14 shown in FIG. 7. FIGS. 14A and 14B correspond to Steps S15 to S18 shown in FIG. 7. FIGS. 15A and 15B correspond to Steps S19 to S21 shown in FIG. 7.

In the ink jet printer 10 according to the embodiment, by operating, for example, the cleaning device 40, the ink discharging surface 21 (see FIG. 5) of the line head 20 can be cleaned by the cleaning belt 41. In order to perform a cleaning operation by controlling the ink jet printer 10 (see FIG. 5), after “start” in FIG. 7, in the first Step S1, the line head 20 is raised and set in a standby state. That is, as shown in FIG. 8A, the line head 20 (represented by dotted lines in FIG. 8A) at a print position P11 directly above the print table 11 is raised to a highest position by the raising-lowering unit, so that the line head 20 is moved as shown by an arrow to a standby position P12 (the line head 20 at this position is represented by a solid line in FIG. 8A). By setting the line head 20 in the standby state at the standby position P12, a space is formed above the print table 11. The line head 20 is positioned in a raising-lowering direction by controlling a head raising-lowering motor (not shown) by counting the number of pulses with reference to a detection position of the print position P11 that is detected by a position sensor (not shown).

Next, in Step S2 shown in FIG. 7, the cleaning device 40 is set between the print table 11 and the line head 20 (represented by the solid line in FIG. 8A) at the standby position P12. That is, the cleaning device 40 that is situated at a withdrawal position P21 as a result of being moved away from the line head 20 is moved as indicated by an arrow shown in FIG. 8B, and reaches a cleaning position P22 where it is positioned directly below the line head 20. Accordingly, the cleaning position 40 is ordinarily at the withdrawal position P21. When the line head 20 is displaced from the print position P11 to the standby position P12, the cleaning device 40 moves to the cleaning position P22. Then, the cleaning device 40 is set so as to oppose the ink discharging surface 21. Perpendicular movement of the line head 20 and horizontal movement of the cleaning device 40 are in a mutually exclusive relationship.

Next, in Step S3 shown in FIG. 7, the line head 20 is lowered. That is, as shown in FIG. 9A, the line head 20 (represented by dotted lines in FIG. 9A) at the standby position P12 is lowered as indicated by an arrow, so that the line head 20 is moved to a press-contact position P13 (the line head 20 at this position is represented by a solid line in FIG. 9A). This causes the ink discharging surface 21 to contact the cleaning belt 41 under a proper pressure. Press-contact force thereof is adjusted by the raising spring 45 (see FIG. 6).

In Step S4 shown in FIG. 7, the belt frame 43 disposed at the home position (cleaning start position) using the position sensor 58 (see FIG. 5) (that is, the cleaning belt 41 at a start position P31) is moved in the outward path shown in FIG. 5 by rotationally driving the belt driving motor 56. That is, when the raising-lowering unit causes the ink discharging surface 21 to contact the cleaning belt 41, the belt frame 43 is moved. With reference to the home position, the number of pulses for rotationally driving the belt driving motor 56 is counted.

Next, in Step S5, it is determined whether or not the number of pulses is reached a prescribed number N1 of pulses. If the prescribed number N1 is been reached, the belt driving motor 56 is controlled to stop the movement of the belt frame 43 in Step S6. Therefore, as shown in FIG. 9B, the cleaning belt 41 (represented by dotted lines in FIG. 9B) at the start position P31 is moved in the outward path as indicated by an arrow until the prescribed number N1 of pulses is reached. When the belt frame 43 is moving, the installation rollers 42 (see FIGS. 6A and 6B) are not rotationally driven due to a stop control of the belt rotating motor 46 (see FIG. 6). Therefore, the cleaning belt 41 does not rotate.

Therefore, the cleaning belt 41 shown in FIG. 9 slides along the ink discharging surface 21 in the nozzle arrangement direction (see FIG. 5). From the start position P31 (indicated by the dotted lines in FIG. 9B), the cleaning belt 41 is displaced to an intermediate position P32 (indicated by a solid line in FIG. 9B) in correspondence with the prescribed number N1 of pulses. As a result, as shown in FIG. 10A, for example, foreign matter, dust, or collected ink adhered to the ink discharging surface 21 during this time is wiped off by moving the cleaning belt 41 that is like a wiper.

Here, as shown in FIG. 10B, the ink discharging surface 21 has steps between the head chips 31 and the flexible sheet 33 (in the line head 20 shown in FIG. 10, the steps are approximately 50 μm). The cleaning belt 41 positioned around the installation rollers 42 and formed of a porous foam material having flexibility, water-absorbing property, and air permeability follows the steps. Therefore, gaps are not formed at corners of the steps. By additive effects with capillarity in pores (cells) in the interior of the porous foam material, the ink is wiped off without, for example, residual ink at the corners of the steps.

When, for example, residual ink is wiped off, a portion of the cleaning belt 41 that contacts the ink discharging surface (that is, a wipe portion) is stained. When cleaning is continued at the same contact portion, cleaning capability is reduced. Therefore, in the embodiment, in Step S6 shown in FIG. 7, the movement of the belt frame 43 is stopped once at the intermediate position P32 during the cleaning operation (that is, between the cleaning start position and the cleaning end position).

Then, in Step S7 shown in FIG. 7, the line head 20 is raised and set in a standby state, to temporarily bring the cleaning belt 41 out of the press-contact state with the ink discharging surface 21. That is, when the belt frame 43 is stopped, the ink discharging surface 21 is not in contact with the cleaning belt 41. Then, in Step S8 shown in FIG. 7, in this state, the cleaning belt 41 is rotated, to change a contact portion (wipe portion) between the cleaning belt 41 and the ink discharging surface 21.

FIG. 11A shows a state corresponding to Step S7 shown in FIG. 7, in which the line head 20 (represented by dotted lines in FIG. 11A) at the press-contact position P13 is raised to the standby position P12 as indicated by an arrow (the line head 20 at this position is represented by a solid line in FIG. 11A). Then, the installation roller 42b is rotationally driven by the belt rotating motor 46 shown in FIG. 6, to rotate the cleaning belt 41 by a predetermined movement amount as shown in FIG. 11B corresponding to Step S8 shown in FIG. 7. Therefore, a portion stained by contacting the ink discharging surface 21 is changed, to restore cleaning capability. That is, by changing a wipe portion of the cleaning belt 41 during the cleaning operation, there are no longer differences between the cleaning capabilities (such as absorbing power of the cleaning belt 41) from the cleaning start position to the cleaning end position. As a result, the entire ink discharging surface 21 is uniformly wiped.

In this case, if the entire circumference of the cleaning belt 41 has already contacted the ink discharging surface 21 once, a new portion does not appear even if the cleaning belt 41 is rotated. However, the front and back surfaces of the cleaning belt 41 contact outside air while it rotates, and air permeability is increased, thereby prompting drying of the cleaning belt 41. Therefore, even if a portion has been used for wiping and thus has reduced absorbing power, the moisture of the absorbed ink is evaporated, so that absorbing power of the cleaning belt 41 is restored. That is, if the cleaning belt 41 is rotated, a portion of the cleaning belt 41 whose flexibility, water-absorbing property, and air permeability have been restored by drying the cleaning belt 41 can be brought into contact with the ink discharging surface 21. Therefore, high cleaning performance can be maintained over a long period of time. Staining and damaging of the ink discharging surface 21 resulting from reverse flow of, for example, absorbed ink to the ink discharging surface 21 do not occur.

After restoring the cleaning capability in this way, in Step S9 shown in FIG. 7, the line head 20 is lowered again. That is, as shown in FIG. 12A, the line head 20 (represented by dotted lines in FIG. 12A) at the standby position P12 is lowered as indicated by an arrow to the press-contact position P13 (the line head 20 at this position is represented by a solid line in FIG. 12A). Therefore, the cleaning belt 41 re-contacts the ink discharging surface 21 under a proper pressure.

In Step S10 shown in FIG. 7, the belt frame 43 is moved again in the outward path and the cleaning operation is continued, and the number of pulses for rotationally driving the belt driving motor 56 (shown in FIG. 5) is counted. Then, in Step S11, a determination is made as to whether or not a prescribed number N2 of pulses is reached. If the prescribed number N2 of pulses is reached, the movement of the belt frame 43 is stopped in Step S12. Therefore, as shown in FIG. 12B, the cleaning belt 41 (represented by dotted lines in FIG. 12B) at the intermediate position P32 is moved in the outward path as indicated by an arrow until the prescribed number N2 of pulses is reached. Here, since the belt rotating motor 46 (shown in FIG. 6) is not rotationally driven, the cleaning belt 41 is not rotated.

Therefore, the cleaning belt 41 shown in FIG. 12 slides along the ink discharging surface 21 in the nozzle arrangement direction (see FIG. 5). Then, from the intermediate position P32 (represented by the dotted lines in FIG. 12B), the cleaning belt 41 is displaced to an end position P33 (represented by a solid line in FIG. 12B) in correspondence with the prescribed number N2 of pulses. As a result, for example, foreign matter, dust, or collected ink adhered to the ink discharging surface 21 during the displacement is wiped off by the movement of the cleaning belt 41 in the outward path.

In this way, the cleaning in the entire outward path is ended. In the embodiment, cleaning is also performed in the return path. Therefore, in order not to reduce cleaning capability in the return path, in Step S13 shown in FIG. 7, the line head 20 is raised and set in a standby state. Thereafter, in Step S14, the cleaning belt 41 is rotated, to change a contact portion between the cleaning belt 41 and the ink discharging surface 21.

FIG. 13A shows a state corresponding to Step S13 shown in FIG. 7. The line head 20 (represented by dotted lines in FIG. 13A) at the press-contact position P13 is raised as indicated by an arrow to the standby position P12 (the line head 20 at this position is represented by a solid line in FIG. 13A). Then, the installation roller 42b (shown in FIG. 6) is rotationally driven, to rotate the cleaning belt 41 by a predetermined movement amount as shown in FIG. 13B corresponding to Step S14 shown in FIG. 7. Therefore, a portion stained by contact with the ink discharging surface 21 is changed, to restore cleaning capability.

After restoring the cleaning capability in the return path in this way, in Step S15 shown in FIG. 7, the line head 20 is lowered again. That is, as shown in FIG. 14A, the line head 20 (represented by dotted lines in FIG. 14A) at the standby position P12 is lowered as indicated by an arrow to the press-contact position P13 (the line head 20 at this position is represented by a solid line in FIG. 14A). Therefore, the cleaning belt 41 re-contacts the ink discharging surface 21 under a proper pressure.

Thereafter, in Step S16 shown in FIG. 7, the belt frame 43 is moved, this time, in the direction of the return path, and the number of pulses for rotationally driving the belt driving motor 56 (see FIG. 5) is counted. That is, as with the cleaning in the outward path, the cleaning belt 41 is displaced from the end position P33 (represented by dotted lines in FIG. 14B) to the intermediate position P32 (also represented by dotted lines in FIG. 14B), to clean the ink discharging surface 21. Then, at the intermediate position P32, the cleaning belt 41 is rotated, and cleaning capability is restored. The operation at the intermediate position P32 is the same as that for the cleaning in the outward path. Therefore, they will not be illustrated.

Further, the cleaning belt 41 (represented by dotted lines in FIG. 14B) at the intermediate position P32 is displaced to the start position P31 (represented by a solid line in FIG. 14B). Then, the displacement to the start position P31 is controlled by detecting the home position in Step S17 shown in FIG. 7. That is, when the home position of the belt frame 43 is detected by the position sensor 58 (shown in FIG. 5), in the next Step S18, the belt frame 43 is stopped, so that the cleaning belt 41 returns to the start position P31. Therefore, as in the outward path, the cleaning of the ink discharging surface 21 in the entire return path ends.

After the ink discharging surface 21 is completely cleaned in this way, in Step S19 shown in FIG. 7, the line head 20 is raised and is set in a standby state. That is, as shown in FIG. 15A, the line head 20 (represented by dotted lines in FIG. 15A) at the press-contact position P13 is moved as indicated by an arrow to the standby position P12 (the line head 20 at this position is represented by a solid line in FIG. 15A). Then, the line head 20 is caused to be in the standby state at the standby position P12, so that a space is formed above the cleaning device 40.

Next, in Step S20 shown in FIG. 7, the cleaning device 40 is withdrawn. That is, as shown in FIG. 15A, the cleaning device 40 at the cleaning position P22 is moved as indicated by an arrow, and is displaced to the withdrawal position P21. This ends the series of cleaning operations. When printing is re-started afterwards, the line head 20 is returned to the print position P11 as shown by the dotted lines in FIG. 8A.

When printing ends, in Step S21 shown in FIG. 7, the line head 20 is lowered to a lowest position, and the process ends. That is, as shown in FIG. 15B, the line head 20 (represented by dotted lines in FIG. 15B) at the standby position P12 is lowered as indicated by an arrow to a cap position P14. This causes the ink discharging surface 21 of the line head 20 to be sealed and protected by the head cap 12. Therefore, for example, clogging or drying of the nozzles 32 (see FIG. 4) is prevented from occurring.

As described above, according to the ink jet printer 10 (method of controlling the ink jet printer 10) according to the embodiment, for example, collected ink adhered to the ink discharging surface 21 can be wiped off by sliding the cleaning belt 40 along the ink discharging surface 21. By changing a wipe portion by rotating the endless cleaning belt 41 at a predetermined timing, it is possible to, not only prevent the cleaning capability from being reduced during the cleaning operation, but also restore the cleaning capability of a portion that has been used for a wiping operation. As a result, it is possible to obtain a cleaning effect in which the entire ink discharging surface 21 is uniformly wiped without uneven wiping. In addition, this is particularly effective for the line head 20 having a wide cleaning range and absorbing a large amount of ink.

The present invention is not limited to the above-described embodiment, so that, for example, various modifications may be made as described below.

(1) Although, in the embodiment, the ink jet printer 10 is a line ink jet printer 10 including the line head 20, the present invention is applicable to other printers, such as a serial printer that performs printing by moving the head in a widthwise direction of a recording sheet. In addition, the present invention is applicable to, for example, a copying machine or a facsimile in addition to a printer.

(2) Although, in the embodiment, the guide shaft 52, the moving driving belt 53, the moving driving pulley 54, the tension pulley 55, the belt moving motor 56, and the movement transmitting belt 57 are used in the moving unit of the belt frame 43, the present invention is not limited thereto. For example, a gear, a belt, a cam, a piston, or a combination thereof may also be used. In addition, although, for example, the belt rotating motor 46, the rotationally driving pulley 47, the rotation transmitting belt 48, and the rotationally driving belt 49 are used in the rotationally driving unit of the installation roller 42, the present invention is not limited thereto. For example, a gear, a belt, a cam, a piston, or a combination thereof may also be used.

(3) Although, in the embodiment, a wipe portion is changed by rotating the cleaning belt 41 at a predetermined timing between the cleaning start position and the cleaning end position, the number of rotations may be any number of rotations. In addition, the cleaning belt 41 may be rotated at a point other than the intermediate position P32 and the end position P33. Further, during cleaning, the cleaning belt 41 may not be rotated at all. Still further, although, in the embodiment, the cleaning belt 41 is not rotated while the belt frame 43 is moving, the cleaning belt 41 can be rotated in accordance with a movement speed or independently of the movement speed.

(4) Although, in the embodiment, the cleaning is completed by reciprocating the belt frame 43 once, the present invention is not limited thereto. The cleaning may be performed for only one of the paths, or the belt frame 43 may be repeatedly reciprocated a plurality of times during one cleaning operation. For example, in the ink jet printer 10 that can print up to an A4-size horizontal width, when printing is performed on a postcard, only a printing range (that is, an ink discharge range with respect to the postcard) may be cleaned.

The present application contains subject matter related to that disclosed in Japanese Priority Patent Application JP 2008-137321 filed in the Japan Patent Office on May 26, 2008, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A liquid discharging device comprising:
a plurality of nozzles for discharging liquid;
a liquid discharging head having a nozzle row in which each of the nozzles is arranged in one direction;
an endless cleaning belt for cleaning a liquid discharging surface of the liquid discharging head;
an installation roller on which the cleaning belt is rotatably installed;
a supporting frame that supports the installation roller so that a widthwise direction of the cleaning belt is set at an angle with the arrangement direction of the nozzles, and so that the cleaning belt positioned around the installation roller is capable of contacting the liquid discharging surface;
moving means for moving the supporting frame in the arrangement direction of the nozzles; and
rotationally driving means for rotationally driving the installation roller.

2. The liquid discharging device according to claim 1, further comprising:
raising-lowering means for lowering or raising the liquid discharging head so that the liquid discharging surface and the cleaning belt are in contact with each other or not in contact with each other,
wherein the moving means moves the supporting frame when the raising-lowering means causes the liquid discharging surface to contact the cleaning belt, and
wherein the rotationally driving means does not rotationally drive the installation roller when the moving means is moving the supporting frame.

3. The liquid discharging device according to claim 1, further comprising:
raising-lowering means for lowering or raising the liquid discharging head so that the liquid discharging surface and the cleaning belt are in contact with each other or not in contact with each other,
wherein the moving means stops the movement of the supporting frame at least once between a start position of the movement of the supporting frame and an end position of the movement of the supporting frame,
wherein the raising-lowering means does not cause the liquid discharging surface to contact the cleaning belt when the moving means stops the movement of the supporting frame, and
wherein the rotationally driving means rotationally drives the installation roller and changes a contact portion between the liquid discharging surface and the cleaning belt when the raising-lowering means does not cause the liquid discharging surface to contact the cleaning belt.

4. The liquid discharging device according to claim 1, wherein the liquid discharging head has a plurality of the nozzle rows disposed in parallel with each other, and
wherein the cleaning belt has a width that is larger than an interval between the nozzle rows at both ends disposed in parallel with each other.

5. A method of controlling a liquid discharging device including a plurality of nozzles for discharging liquid, a liquid discharging head having a nozzle row in which each of the nozzles is arranged in one direction, an endless cleaning belt for cleaning a liquid discharging surface of the liquid discharging head, an installation roller on which the cleaning belt is rotatably installed, a supporting frame that supports the installation roller so that a widthwise direction of the cleaning belt is set at an angle with the arrangement direction of the nozzles, and so that the cleaning belt positioned around the installation roller is capable of contacting the liquid discharging surface, moving means for moving the supporting frame in the arrangement direction of the nozzles, and rotationally driving means for rotationally driving the installation roller, the method comprising the steps of:
moving the supporting frame by the moving means when the liquid discharging surface and the cleaning belt are in contact with each other; and
rotationally driving the installation roller by the rotationally driving means when the liquid discharging surface and the cleaning belt are not in contact with each other.

6. The method of controlling the liquid discharging device according to claim 5, wherein the liquid discharging device further includes raising-lowering means for lowering or raising the liquid discharging head so that the liquid discharging surface and the cleaning belt are in contact with each other or not in contact with each other,
wherein the moving means stops the movement of supporting frame at least once between a start position of the movement of the supporting frame and an end position of the movement of the supporting frame,
wherein the raising-lowering means does not cause the liquid discharging surface to contact the cleaning belt when the movement of the supporting frame is stopped,
wherein, in this state, the rotationally driving means rotationally drives the installation roller until a contact portion between the liquid discharging surface and the cleaning belt is changed,
wherein the raising-lowering means thereafter causes the liquid discharging surface and the cleaning belt to contact each other; and
wherein the moving means moves the supporting frame again.

7. A liquid discharging device comprising:
a plurality of nozzles for discharging liquid;
a liquid discharging head having a nozzle row in which each of the nozzles is arranged in one direction;
an endless cleaning belt for cleaning a liquid discharging surface of the liquid discharging head;
an installation roller on which the cleaning belt is rotatably installed;
a supporting frame that supports the installation roller so that a widthwise direction of the cleaning belt is set at an angle with the arrangement direction of the nozzles, and so that the cleaning belt positioned around the installation roller is capable of contacting the liquid discharging surface;
a moving unit moving the supporting frame in the arrangement direction of the nozzles; and
a rotationally driving unit rotationally driving the installation roller.
